(19) United States
(12) Patent Application Publication
(10) Pub. No.: US 2025/0101604 A1
(43) Pub. Date: Mar. 27, 2025

(54) SYSTEM, APPARATUS AND METHOD FOR PRODUCING ELECTROCHEMICALLY ACTIVATED SOLUTIONS

(71) Applicant: Annihilare Medical Systems, Inc., LINCOLNTON, NC (US)

(72) Inventors: Clay Parker Sipes, HICKORY, NC (US); Marion E. Paris, JR., LINCOLNTON, NC (US)

(73) Assignee: Annihilare Medical Systems, Inc., LINCOLNTON, NC (US)

(21) Appl. No.: 18/975,428

(22) Filed: Dec. 10, 2024

Related U.S. Application Data
(63) Continuation-in-part of application No. 17/344,951, filed on Jun. 11, 2021.

(51) Int. Cl. C25B 1/26; C25B 9/19; C25B 9/65; C25B 15/025; C25B 15/08

(52) U.S. Cl. CPC C25B 1/26; C25B 9/19; C25B 9/65; C25B 15/025; C25B 15/087

(57) ABSTRACT

A system and apparatus operable for producing the HOCl and hydroxide solutions utilizing electricity and a mixture of water and brine in an electrolysis cell includes a fixed flow restrictor (FFR) operable for controlling at least one of a pH of the HOCl solution and a free available chlorine (FAC) in the HOCl solution. The FFR includes an insert having a fluid passageway with an inner diameter and length selected to control the pH and/or the FAC of the HOCl solution. A plurality of interchangeable FFRs or a multiple FFR manifold is provided so that the pH of the HOCl solution and/or the FAC of the HOCl solution can be precisely controlled. A self-balancing system and method optimizes the electrochemical production of HOCl and hydroxide solutions by the precise management and control of the water flow, electrolyte concentration and electric current variables in an EAW process.

### CROSS-REFERENCE TO RELATED APPLICATION

This non-provisional application is a continuation-in-part (CIP) of U.S. application Ser. No. 17/344,951 filed on Jun. 11, 2021, the entire contents of which are incorporated herein by reference.

### FIELD OF THE INVENTION

The present invention relates generally to an improved system, apparatus and method for producing electrochemically activated (ECA) solutions. More particularly, the invention relates to a system, apparatus and method for producing cleaning, degreasing, sanitizing and disinfecting solutions utilizing an electrochemically activated water (EAW) process. In an advantageous aspect, the invention is a system and apparatus for producing hypochlorous acid (HOCl) solutions and hydroxide solutions, and a method for controlling the pH of the HOCl solution and/or the free available chlorine (FAC) in the HOCl solution. In a further advantageous aspect, the invention is a system and method for optimizing the electrochemical production of HOCl solutions and hydroxide solutions by the precise management and control of the water flow, electrolyte concentration and electric current variables in an EAW process.

### BACKGROUND OF THE INVENTION

Many facilities, including hospitals, nursing homes, prisons, schools and public terminals, are highly susceptible to multi-drug resistant organisms (MDROs), commonly referred to as infectious bacteria and viruses. For example, the Centers for Disease Control and Prevention (CDCP) estimates that infections acquired from healthcare and food service facilities kill more individuals each year than vehicle accidents, breast cancer or AIDS. As a result, the Environmental Protection Agency (EPA) and the Food and Drug Administration (FDA) prescribe effective cleaning and disinfecting procedures to be used in facilities that provide healthcare services and/or food services. In response, hospitals, nursing homes, prisons and schools have instituted detailed cleaning and disinfecting protocols along with intensive training programs for environmental services personnel to ensure that areas accessed by patients, staff and the public are clean and hygienic.

The aforementioned facilities, especially healthcare facilities, have historically utilized a variety of high, medium and low level disinfectants, including formaldehyde, hydrogen peroxide, peracetic acid and chlorine-releasing agents (CRAs), including sodium hypochlorite, iodophor and phenol solutions. Recently, solutions of hypochlorous acid (HOCl) have been introduced as an effective and environmentally friendly alternative to traditional disinfectants. HOCl is a weak acid formed when chlorine dissolves in water and partially dissociates. Consequently, HOCl acts as an oxidizer and a primary disinfecting agent in a chlorine solution. The beneficial characteristics attributed to HOCl include that it is a highly effective disinfectant for destroying infectious bacteria and viruses, most notably C. diff, E-coli, MRSA (Staph), Salmonella, Tuberculosis, Human Immunodeficiency Virus (HIV), and Severe Acute Respiratory Syndrome (SARS). Despite being highly effective, HOCl is relatively harmless to humans at concentrations sufficient for effective sanitizing and disinfecting. Consequently, HOCl solutions are approved for use as sanitizers and disinfectants in hospitals, nursing homes, prisons, schools and public terminals.

Other cleaning and disinfectant agents commonly used in the aforementioned facilities are not as effective or as environmentally friendly as HOCl in destroying harmful and deadly bacteria and viruses. As a result, it is not uncommon for individuals to contract serious illnesses from the bacteria and viruses at those facilities that are treated with other cleaning and disinfecting agents. The inability to effectively destroy infectious organisms increases healthcare costs and causes physical harm to individuals that can be prevented with the use of a more effective and environmentally friendly HOCl cleaning and disinfecting agent.

Although highly effective, HOCl has a limited lifespan of effectiveness as a sanitizing and disinfecting agent, commercially referred to as “shelf life.” Over time, HOCl decomposes to chloric acid, hydrochloric acid, and oxygen; none of which separately exhibits the same desirable sanitizing and disinfecting properties as a full strength HOCl solution. The shelf life for HOCl solution as a sanitizing and disinfecting agent is limited from the time it is produced based on its free available chlorine concentration. As used herein, the term “free available chlorine” (FAC) is intended to mean the portion of total chlorine in the solution that is present as hypochlorous acid (HOCl) or hypochlorite ion (OCl—). Consequently, it is imperative to take steps to ensure that an effective HOCl solution is being used by environmental services personnel in an established sanitizing and disinfecting protocol at facilities such as hospitals, nursing homes, prisons, schools and public terminals. Specifically, it is essential that environmental services personnel use an HOCl solution that is within an acceptable life cycle of effectiveness for its sanitizing and/or disinfecting purpose.

Sodium chloride (NaCl) is typically the preferred electrolyte salt for producing HOCl solutions due to its relative availability, lower cost and efficiency. Furthermore, the electrolysis byproduct sodium hydroxide (NaOH) is generally more useful, for example as a cleaning or degreasing agent, than the byproducts resulting from other electrolyte salts. However, other electrolyte salts, such as potassium chloride (KCl), lithium chloride (LiCl), may also be used in the electrolysis process to produce HOCl solutions. The use of other electrolyte salts necessarily results in the production of corresponding hydroxides, for example potassium hydroxide (KOH) or lithium hydroxide (LiOH). Accordingly, any reference in this disclosure to NaCl as the electrolyte salt and NaOH solutions as the hydroxide byproduct of the HOCl solutions is intended to include alternative electrolyte salts and corresponding hydroxides, wherever applicable.

Another critical component in the production of an effective HOCl solution is control of the hydrogen ion concentration, commonly referred to as the “pH” of the solution. In the production of HOCl solutions in an EAW process utilizing an electrolysis cell, the byproduct NaOH essentially dictates the pH of the HOCl solution because NaOH has a naturally higher pH. Consequently, the more NaOH present in the EAW process the higher the pH of the HOCl. Conversely, the less NaOH present in the EAW process the lower the pH of the HOCl. Existing systems and apparatus for producing HOCl and NaOH solutions utilize a flow restrictor in the form of a needle valve, pump or electrically controlled valve to increase or decrease backpressure on the NaOH solution output as a means for controlling the pH of the HOCl solution output. Backpressure causes a portion of the NaOH solution in an NaOH solution output line to re-circulate through the electrolysis cell instead of into the NaOH solution receptacle. As a result, the additional NaOH solution raises the pH of the HOCl solution. Thus, the pH of the HOCl solution can be adjusted upwards or downwards using the needle valve, pump or controller to increase or decrease backpressure on the NaOH solution output and thereby increase or decrease, respectively, the NaOH solution re-circulated through the electrolysis cell.

The needle valve, pump or electronic valve allows a technician to balance the flow of the NaOH solution between the electrolysis cell and the NaOH output receptacle, and in so doing, calibrate the pH of the HOCl solution to a desired pH between about 4.5 and about 7.5, and more particularly between about 5.5 and about 7.0. However, these balancing mechanisms also have the negative effect of introducing the opportunity for an inexperienced or inattentive technician to tamper with the needle valve, pump or electronic valve settings, thereby causing an inconsistent pH of the HOCl solution. Furthermore, a needle valve, pump or electronic valve adversely increases the cost, complexity and maintenance of a system and apparatus for producing HOCl and NaOH solutions. Consequently, it would be advantageous to eliminate the needle valve, pump or electronic valve, while maintaining a means for precisely controlling the pH of the HOCl solution, as well as the FAC in the HOCl solution.

Electrolysis, by its nature, demands a carefully controlled balance of water flow, electrolyte concentration and electric current. If a precise control of equilibrium is not maintained, the resulting NaOH solution and/or HOCl solution can fall outside the desired concentration, leading to ineffective cleaning, degreasing, sanitizing and disinfecting solutions. In some cases, the imprecise balance of water, electrolyte and electricity can result in damage to the hardware of the electrolysis system. By way of example, an overabundance of fresh water dilutes the electrolyte, rendering the resulting solutions too weak for effective cleaning, degreasing, sanitizing and disinfecting. Conversely, an overly concentrated electrolyte increases the load on the power supply, potentially shutting down or damaging the electrolysis cell due to excessive current demand. Merely upgrading the power supply is not a viable solution since the increased electrical current could allow the concentration of the NaOH solution and/or the HOCl solution to exceed acceptable levels and thereby violate the safety profile for either or both of the ECA solutions.

In traditional fixed electrochemical cells, managing the input ratios of water, electrolyte and electricity is not complicated because the variables are more controlled. In flow-through electrochemical cells, however, the variables are dynamic and must be continually adjusted to maintain homeostasis. Consequently, a self-balancing system that uses integrated current-sensing and flow-sensing technologies to adjust the power delivered to the electrolysis cell based on real-time conditions is ideal.

In view of the foregoing, it is apparent a need exists for an improved system, apparatus and method for producing ECA solutions. A more particular need exists for a system, apparatus and method for producing cleaning, degreasing, disinfecting and sanitizing solutions utilizing an EAW process. A specific need exists for a system and apparatus for producing HOCl and hydroxide solutions, and a method for controlling the pH of the HOCl solution and/or the FAC in the HOCl solution. A further need exists for a system and method for optimizing the electrochemical production of HOCl solutions and hydroxide solutions by the precise management and control of the water flow, electrolyte concentration and electric current variables in an EAW process. The system and method would necessarily produce environmentally safe and effective cleaning and degreasing hydroxide solutions, as well as environmentally safe and highly effective HOCl sanitizing and disinfecting solutions in compliance with EPA and FDA requirements.

Certain objects, features and advantages of the invention will be apparent, or will be readily understood and appreciated by those skilled in the relevant art, with reference to the various aspects and exemplary embodiments of the invention described herein and shown in the accompanying drawing figures. It is intended that the objects, features and advantages of the invention set forth herein be construed in accordance with the ordinary and customary meaning of the elements, terms and limitations of the appended claims given their broadest reasonable interpretation consistent with this written disclosure and the accompanying drawing figures. Some or all objects, features and advantages of the invention, as well as others not expressly or inherently disclosed, may be accomplished by one or more of the aspects and exemplary embodiments described herein and shown in the accompanying drawing figures. Further, the objects, features and advantages of the invention are envisioned to be accomplished individually or in combination with one or more others. Regardless, it is to be understood appreciated that the written description and drawing figures are for illustrative purposes only, and that modifications, substitutions and/or revisions may be made to the aspects and exemplary embodiments without departing from the general concepts of the invention and the intended broad scope, construction and interpretation of the appended claims.

### BRIEF DESCRIPTION OF THE DRAWINGS

The aforementioned objects, features and advantages of the invention will be more fully understood and appreciated when considered with reference to the accompanying drawing figures, in which like reference characters refer to, identify or designate the same or similar parts throughout the several views.

FIG. 1 is a front perspective view of an exemplary embodiment of an improved system, apparatus and method for producing HOCl and hydroxide solutions according to an aspect of the invention.

FIG. 2 is a side perspective view of the system of FIG. 1.

FIG. 3 is a front perspective view of an exemplary embodiment of a generator of FIG. 1 shown with the front cover in an opened position for purposes of clarity.

FIG. 4 is a side perspective view of the generator of FIG. 3.

FIG. 5 is an elevation view of an exemplary embodiment of an electrolysis cell of the generator of FIG. 3.

FIG. 6 is an exploded view of the components of the electrolysis cell of FIG. 5.

FIG. 7 is a side plan view of the anode of the electrolysis cell of FIG. 5.

FIG. 8 is a cross-sectional view of the electrolysis cell of FIG. 5 taken along the line 8-8 indicated in FIG. 5.

FIG. 9 is a cross-sectional view of the anode of FIG. 7 taken along the line 9-9 indicated in FIG. 7.

FIG. 10 is a bottom end view of the electrolysis cell of FIG. 5.

FIG. 11 is an enlarged perspective view of an exemplary embodiment of a fixed flow restrictor (FFR) of the generator of FIG. 3.

FIG. 12 is an enlarged cross-sectional view of the FFR of FIG. 11 taken along the line 12-12 indicated in FIG. 11.

FIG. 13 is a top perspective view of an exemplary embodiment of a fixed flow restrictor (FFR) manifold for controlling the pH of HOCl solutions and/or the free available chlorine (FAC) in HOCl solutions.

FIG. 14 is a bottom plan view of the FFR manifold of FIG. 13.

FIG. 15 is a top plan view of the FFR manifold of FIG. 13

FIG. 16 is a cross-sectional view of the FFR manifold of FIG. 13 taken along the line 16-16 indicated in FIG. 15.

FIG. 17 is a schematic diagram of the components of a system for the precise management and control of the electrolysis variables in an EAW process according to a further aspect of the invention.

FIG. 18 is a flowchart illustrating an exemplary embodiment of a method for the precise management and control of the electrolysis variables in an EAW process according to the further aspect of the invention.

### DETAILED DESCRIPTION OF EXEMPLARY EMBODIMENTS OF THE INVENTION

Various aspects and exemplary embodiments of the present invention are described in greater detail and shown in the accompanying drawing figures. The aspects and exemplary embodiments of the invention described and shown herein are generally directed to an improved system, apparatus and method for producing electrochemically activated (ECA) solutions. More particularly, an improved system, apparatus and method for producing cleaning, degreasing, sanitizing and disinfecting solutions utilizing an electrochemically activated water (EAW) process is disclosed. The EAW process is a technology that produces a cleaning and degreasing solution and a non-synthetic and biodegradable biocide compound sanitizing and disinfecting hypochlorous acid (HOCl) solution. A system, apparatus and associated method utilizing an EAW process according to the invention produces HOCl solutions and hydroxide solutions from water, salt and electricity through an electrolysis cell.

An aspect of the invention is embodied by a system and apparatus operable for producing HOCl solutions and hydroxide solutions, and an associated method for controlling the pH of the HOCl solution and/or the FAC in the HOCl solution. Certain objects, features and advantages of the invention are illustrated herein by exemplary embodiments of a system, apparatus and method for producing HOCl solutions having a desired pH of the HOCl solution and/or a desired FAC in the HOCl solution. In a particularly advantageous embodiment, a generator including an electrolysis cell is operable for controlling the pH of the HOCl solution and/or the FAC in the HOCl solution. A further aspect of the invention is embodied by a system and method that is operable for optimizing the electrochemical production of HOCl solutions and hydroxide solutions by the precise management and control of the water flow, electrolyte concentration and electric current variables in an EAW process. Certain objects, features, and advantages of the invention are illustrated herein by exemplary embodiments of a system, apparatus and method for producing HOCl solutions and hydroxide solutions by an EAW process controlling the water, salt and electricity through an electrolysis cell.

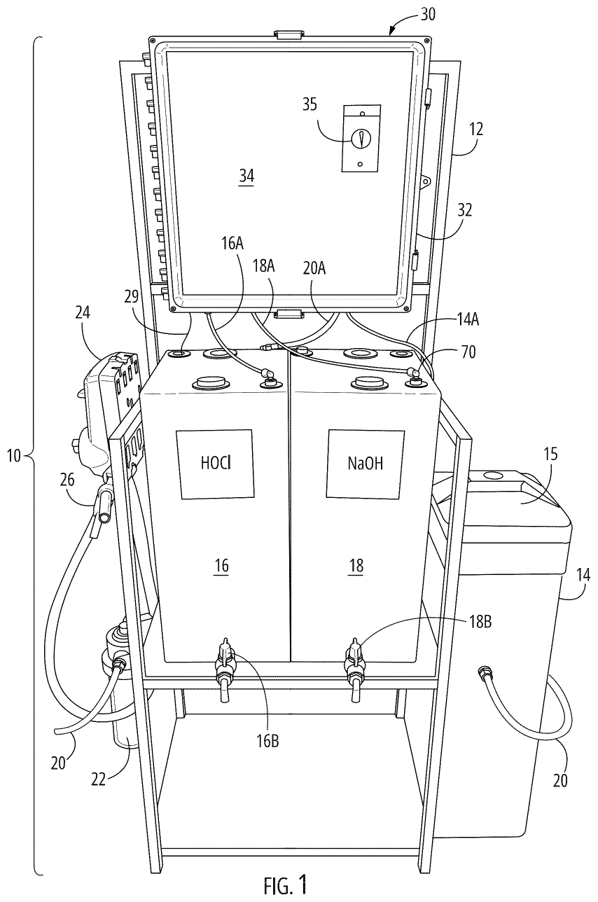

FIG. 1 is a front perspective view showing an exemplary embodiment of an improved system 10 and associated method for producing NaOH solutions and HOCl solutions according to the invention. System 10 includes an optional stand, rack or the like 12 configured for supporting components of the system 10. As shown herein, system 10 comprises a brine tank 14 that is in fluid flow communication with an ECA solutions generator 30 securely mounted onto stand 12. Alternatively, generator 30 may be wall-mounted or free-standing. The brine tank 14 defines an interior compartment (not shown) configured to receive an electrolyte salt, such as high purity sodium chloride (NaCl), potassium chloride (KCl), lithium chloride (LiCl) or similar, and an external source of fresh water to form a suitable saltwater solution, commonly referred to as brine. The selection of the electrolyte salt will necessarily result in the corresponding hydroxide byproduct, for example, sodium hydroxide (NaOH), potassium hydroxide (KOH), lithium hydroxide (LiOH), etc. Accordingly, the present invention is not intended to be limited to NaCl as the electrolyte salt for producing HOCl solutions and NaOH as the hydroxide byproduct of the EAW process.

Brine tank 14 is in fluid flow communication with the generator 30 by means of a brine input conduit 14A. Brine tank 14 is preferably formed from a relatively lightweight, yet durable, chemically resistant and anti-corrosive plastic material, and brine conduit 14A is preferably formed from a chemically resistant and anti-corrosive plastic material, for example polyvinylchloride (PVC) tubing. The PVC tubing of brine conduit 14A may be reinforced with spiral wound polyester yarn for increased strength and durability. Brine tank 14 may have a removable cover 15 providing access to the interior compartment for the purpose of filling the brine tank 14 with the salt and the fresh water. The salt for brine tank 14 is typically provided in the form of one or more salt blocks or salt pellets. As shown herein, brine tank 14 is provided with a fill conduit 20 and an optional drain line (not shown) for regulating the amount of fresh water within the interior compartment of the brine tank 14.

System 10 further comprises a first receptacle 16 that is likewise in fluid flow communication with generator 30, and a second receptacle 18 that is likewise in fluid flow communication with generator 30. First receptacle 16 is configured to receive and retain HOCl solutions produced by the generator 30 through HOCl output conduit 16A. Similarly, second receptacle 18 is configured to receive and retain NaOH solutions produced by the generator 30 through NaOH output conduit 18A. The first receptacle, also referred to herein as HOCl tank 16, is provided with a gravity nozzle in the form of a first spigot 16B for dispensing the HOCl solution from the HOCl tank 16 into another container, for example, a spray bottle (not shown). Likewise, the second receptacle, also referred to herein as NaOH tank 18, is provided with a gravity nozzle in the form of a second spigot 18B for dispensing the NaOH solution from the NaOH tank 18 into another container, for example, a spray bottle (not shown).

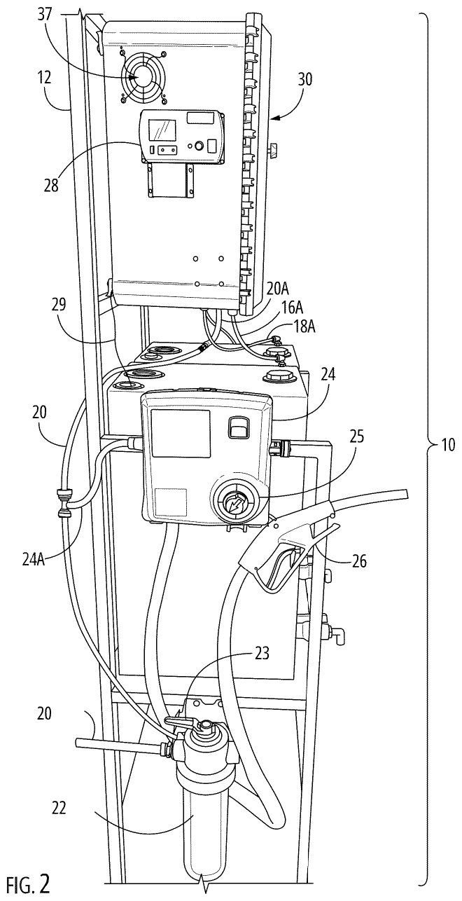

FIG. 2 is a side perspective view of system 10 of FIG. 1. As best shown in FIG. 2, the fill conduit 20 is also configured to deliver the external source of fresh water to the generator 30 through a water input conduit 20A. Preferably, the external source of fresh water is pre-softened and iron-filtered by a water filtration unit 22 to provide pre-treated fresh water to the generator 30. Soluble ferrous iron in water, when in contact with HOCl, will oxidize the soluble ferrous iron to insoluble ferric iron, thus introducing rust into the system 10. Filtration unit 22 has a selector valve 23 for directing the flow of pre-treated fresh water through fill conduit 20 to brine tank 14, or through water input conduit 20A to generator 30, or to a dilution station 24 mounted on the stand 12 of system 10 through a dilution water input conduit 24A. Dilution station 24 is operable for producing additional ECA solutions having different strengths by diluting the HOCl solution or the NaOH solution with fresh water. Dilution station 24 is provided with a selector knob 25 for selecting a desired HOCl and fresh water diluted solution, or alternatively, a desired NaOH and fresh water diluted solution.

By way of example and not limitation, the dilution station 24 is configured to produce cleaning and/or degreasing NaOH solutions having different concentrations, and sanitizing and/or disinfecting HOCl solutions having different FAC concentrations. Regardless, the diluted NaOH solution or diluted HOCl solution selected from the dilution station 24 is dispensed to another receptacle, such as a transport container, spray cart, spray bottle or the like, through an output nozzle 26. System 10 may further comprise a pH meter 28 that is operable for visually monitoring the pH of the HOCl solution in the HOCl tank 16 by means of a pH probe wire 29 that extends from within the HOCl tank 16 through the generator 30 to pH meter 28. Preferably, the readable gauge of the pH meter 28 is located on the exterior of the generator 30 so that a technician can monitor the pH of the HOCl solution produced by the generator 30 without having to access the interior of the generator 30.

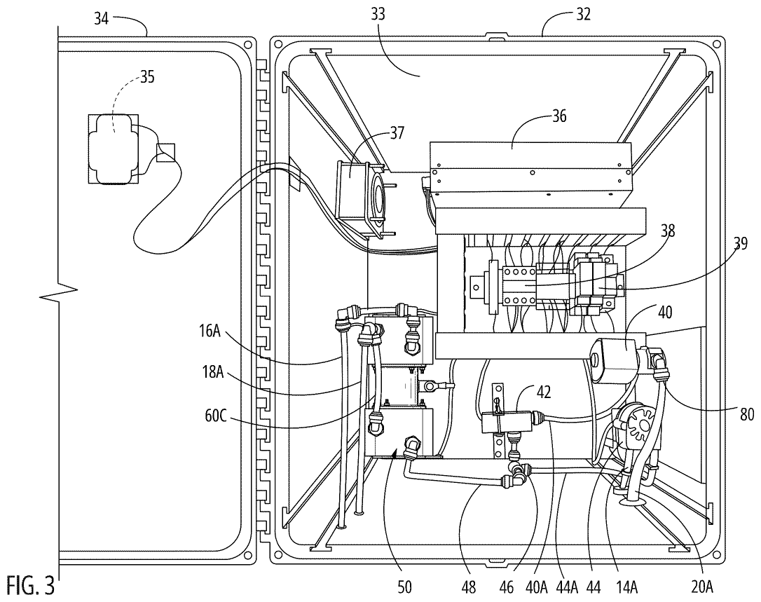

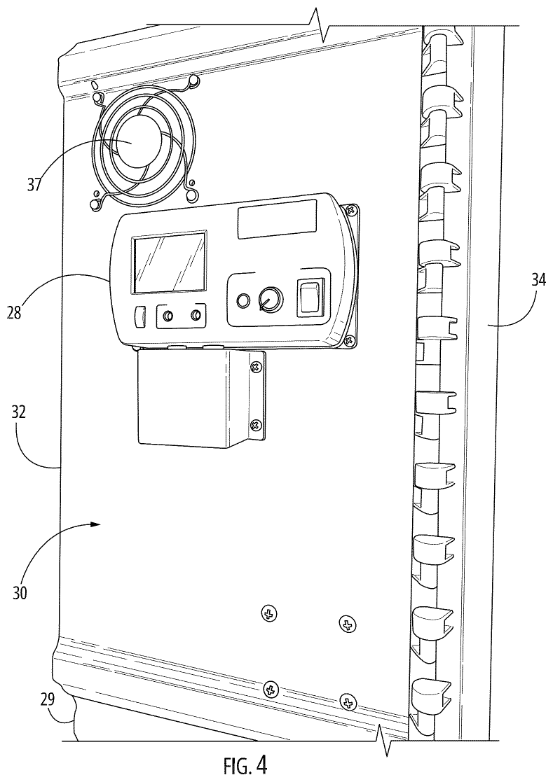

FIG. 3 is a front perspective view showing an exemplary embodiment of the generator 30 of system 10, while FIG. 4 is a side perspective view of the generator 30. Generator 30 comprises a generally cuboid, hollow housing 32 that defines an interior compartment 33 for housing components of the generator 30. Housing 32 is provided with an openable front cover 34 for providing access to the interior compartment 33. As shown herein, front cover 34 is in the form of an access panel, door or the like that is attached to the housing 32 by a hinge or the like so that the front cover 34 is movable between a closed position depicted in FIG. 1 and an opened position depicted in FIG. 3. The front cover 34 is shown in the opened position in FIG. 3 for the purpose of clarity to view internal components of the generator 30. The generator 30 may include an electrical on-off switch or mechanical timer switch 35 on the front cover 34 of the housing 32 to allow a technician to operate the generator 30 for a predetermined period of time, for example a run-time of 30, 60 or 90 minutes, without the technician having to access the components disposed within the interior compartment 33 of the housing 32. If desired, the housing 32 may also be provided with a means for securely locking the front cover 34 on the housing 32, for example a combination lock, to restrict access to the interior compartment 33 of the housing 32 to authorized personnel as a precaution against inadvertent or malicious tampering with the electrical and mechanical components within the interior compartment 33 of generator 30.

As shown in FIG. 3, generator 30 further comprises a DC power supply 36 for supplying electrical power to electrical components of the generator 30. Power supply 36 is preferable cooled by a fan 37 disposed on an interior side wall of the generator 30 adjacent the power supply 36. A contactor switch 38 electrically coupled to the power supply 36 is provided for controlling the supply of electrical power to the electrical components of the generator 30 in a timed manner. For example, the electrical contactor switch 38 may supply 12/24 VDC power to an electrolysis cell 50 (to be described hereafter) and 120/240 VAC power to pumps, solenoids, timers, etc. Consequently, contactor switch 38 may comprise a fuse box, a 12 VAC to 12 VDC transformer, terminal blocks for routing wiring and/or a timer relay 39. As mentioned previously and best shown in FIG. 3, water input conduit 20A delivers pre-treated fresh water from the external source of fresh water to the generator 30. Water input conduit 20A is in fluid flow communication with a solenoid valve 40 and further, through a fresh water flow conduit 40A, with a flow sensor switch 42 that controls the on/off supply of fresh water to the generator 30.

Flow sensor switch 42 in conjunction with timer relay 39 prevents the overproduction and release of harmful chlorine (Cl) gas for safety purposes, while ensuring the quality of the HOCl solution, by shutting down operation of the generator 30 in the event of an insufficient fresh water supply. The flow sensor switch 42 is operable for regulating the amount of pre-treated fresh water delivered to generator 30 via water input conduit 20A that is mixed with brine delivered to generator 30 from the brine tank 14 via brine input conduit 14A. Generator 30 further comprises a brine pump 44 for pumping brine delivered to generator 30 via brine input conduit 14A through brine flow conduit 44A to a tee-fitting 46 where the 100% fresh water and the 100% brine are combined together to form a diluted mixture of fresh water and brine that is delivered to electrolysis cell 50 through water/brine input conduit 48. In one embodiment, the brine pump 44 is a positive displacement pump, and particularly, is an electromechanical peristaltic pump operable for pumping the brine at a predetermined constant flow rate, in which case the DC motor and tubing size selection of the peristaltic pump 44 determines the flow rate of the brine.

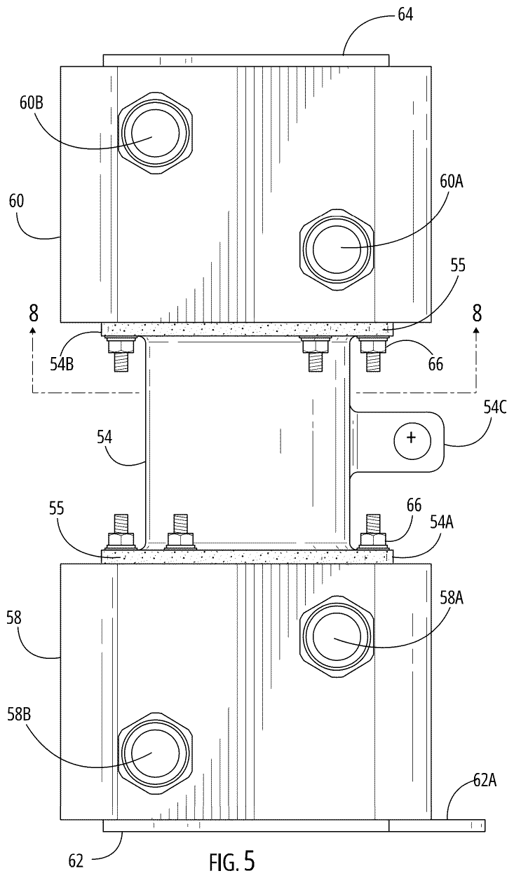

Electrolysis cell 50 of generator 30 is configured to receive the mixture of fresh water and brine via the water/brine input conduit 48. FIG. 5 is an elevation view of an exemplary embodiment of an electrolysis cell 50 of the generator 30. FIGS. 6-10 show components of the electrolysis cell 50 in greater detail. Electrolysis cell 50 combines the mixture of fresh water and brine with electrical current provided by the system 10 to produce ECA solutions utilizing the EAW process in a manner that is well known to those of ordinary skill in the art. Specifically, the electrolysis cell 50 of generator 30 produces an HOCl solution that is delivered to the HOCl tank 16 through the HOCl output conduit 16A and an NaOH solution that is delivered to the NaOH tank 18 through the NaOH output conduit 18A. As previously mentioned, the HOCl solution in the HOCl tank 16 and the NaOH solution in the NaOH tank 18 may be diluted thereafter by dilution station 24 to produce additional cleaning, degreasing, sanitizing and disinfecting solutions having various strengths and/or concentrations of FAC measured in parts-per-million (PPM).

As best shown in FIG. 5, and particularly in FIG. 6, electrolysis cell 50 comprises a generally cylindrical cathode 52 and a generally cylindrical anode 54 separated by a generally cylindrical ion exchange membrane 56 that is disposed concentrically between the cathode 52 and the anode 54. Electrolysis cell 50 further comprises an annular input chamber 58 and an annular output chamber 60 adjacent opposed ends of the anode 54. The input chamber 58 is configured for receiving the mixture of fresh water and brine from the water/brine input conduit 48 of the generator 30. Output chamber 60 is configured for delivering the HOCl solution to the HOCl output conduit 16A and for delivering the NaOH solution to the NaOH output conduit 18A, as will be described hereafter. The electrolysis cell 50 further comprises an input end cap 62 made of an electrically conductive material that is in electrical contact with the cathode 52, and an output end cap 64 made of an electrically conductive material that likewise is in electrical contact with the cathode 52. For ease of assembly, the input end cap 62 may be integrally formed with the cathode 52 as shown in FIG. 6 and mechanically attached to the input chamber 58, while the output end cap 64 may be separate and mechanically attached to the output chamber 60.

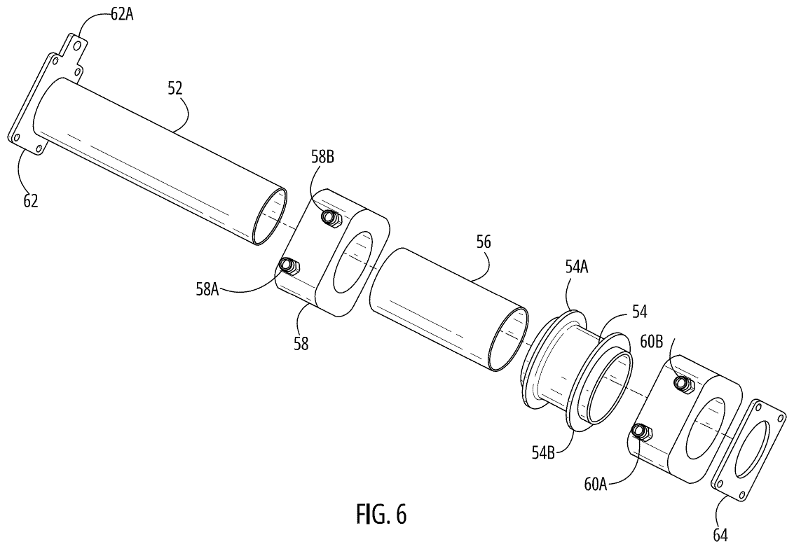

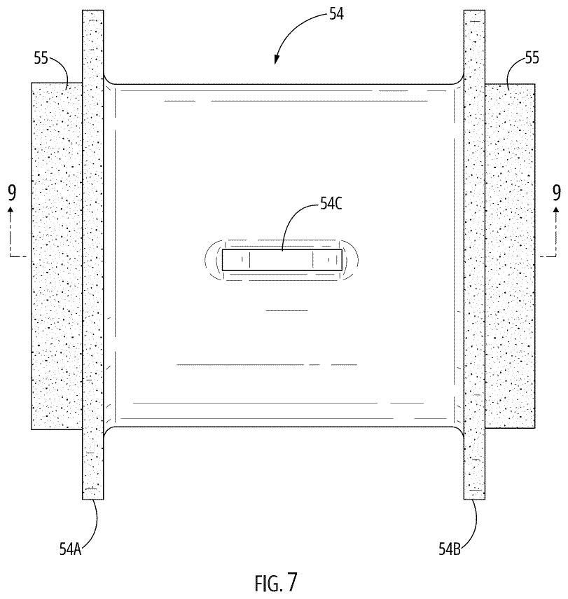

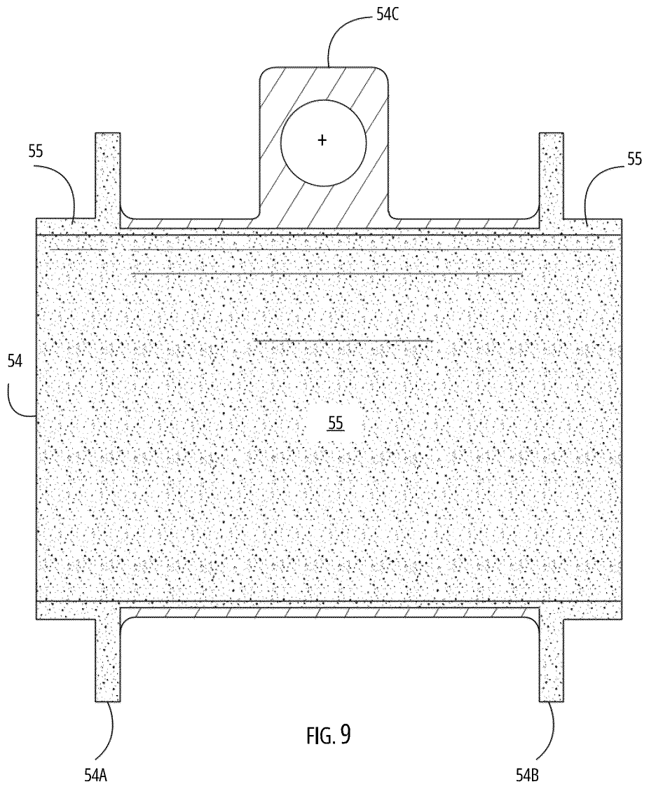

Cathode 52 is formed from a material that is at least a relatively good conductor of electrical current. In an advantageous embodiment, cathode 52 (and consequently input end cap 62) is made of a stainless steel material, such as SS 316, or a titanium material. Anode 54 likewise is formed of a material that is at least a relatively good conductor of electrical current. In an advantageous embodiment, anode 54 is made of a titanium material, such as Ti 6Al-4V. Preferably, the titanium metal of anode 54 is provided with a coating 55 that inhibits the rapid generation of corrosion caused by the highly corrosive environment within the electrolysis cell 50 of the generator 30 during the EAW process. As depicted by FIG. 7 and FIG. 9, the coating 55 may be applied only to the opposed ends of the anode 54 and to the interior surface of the anode 54 exposed to the EAW process within the electrolysis cell 50. The exterior surface of the anode 54 may remain uncoated as shown herein for reduction of cost and weight. The coating 55 is preferably formed from at least one transition metal, and more preferably, the coating 55 is formed from a mixture of platinum group metals. By way of example and not limitation, in an advantageous embodiment the coating 55 is formed from at least one, and preferably, a mixture of ruthenium, rhodium, palladium, iridium and platinum metals.

The membrane 56 disposed between the radially inner cathode 52 and the radially outer anode 54 is formed from a material that has a relatively high porosity and that has a relatively high hardness with sufficient tensile and compressive strength. In one embodiment, membrane 56 is made of a ceramic material, such as aluminum oxide (Al₂O₃) or silicon dioxide (SiO₂). The input chamber 58 and the output chamber 60 are each formed from a material that is relatively resistant to corrosion and that has a relatively high hardness. In one embodiment, input chamber 58 and output chamber 60 are each made of a hard plastic material, such as a thermoplastic polymer. By way of example and not limitation, in an advantageous embodiment the input chamber 58 and the output chamber 60 are each made of a high-density polyethylene (HDPE) material, also known as polyethylene high-density (PEHD) material. If desired, water/brine input conduit 48, HOCl output conduit 16A and NaOH output conduit 18A may each be made of the same HDPE or PEHD material for purposes of material compatibility and cost reduction.

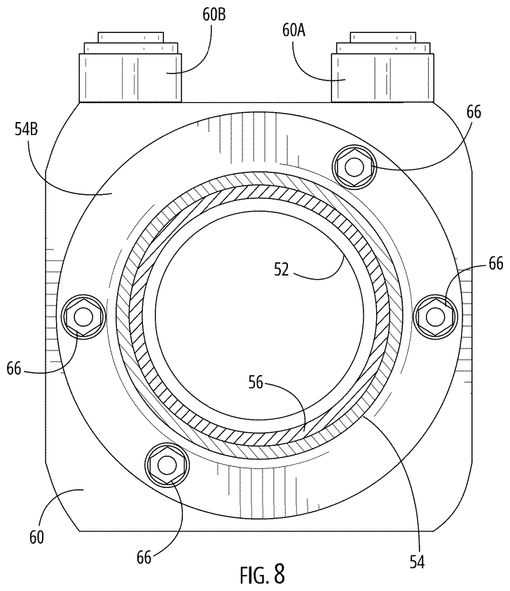

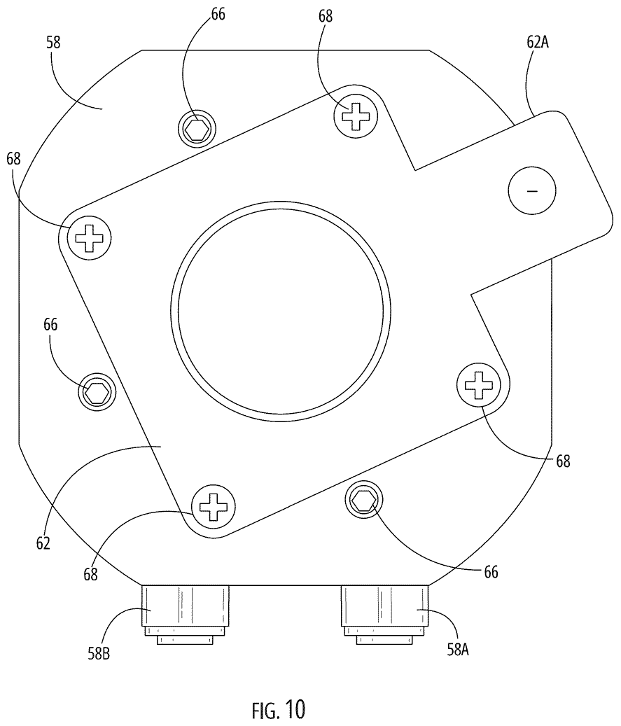

As best depicted by FIG. 5 and FIG. 6, input chamber 58 is positioned over the free end of cylindrical cathode 52. The cylindrical membrane 56 is next positioned over the cathode 56 such that the membrane 56 extends beyond the input chamber 58. Cylindrical anode 54 is next positioned over cylindrical membrane 56 and cathode 52 such that the membrane 56 is disposed radially between the cathode 52 and the anode 54. Anode 54 is attached through a first flange 54A to the input chamber 58 by, for example a plurality of fasteners 66, while input chamber 58 is attached to input end cap 62, for example, by a plurality of fasteners 68, as shown in FIG. 10. The output chamber 60 is next positioned over the free end of the cathode 52 and attached to the anode 54 through a second flange 54B of anode 54 by, for example a plurality of fasteners 66, as shown in FIG. 8. Finally, the output end cap 64 is positioned over the output chamber 60 and attached thereto, for example by a plurality of fasteners 68 (not shown), in the same manner as the input end cap 62 is attached to the input chamber 58.

Input chamber 58 is provided with a first input port 58A configured for introducing the mixture of fresh water and brine delivered to the electrolysis cell 50 through the water/brine input conduit 48. Input chamber 58 is also provided with a second input port 58B for a purpose to be described hereafter. As the mixture of fresh water and brine passes through the electrolysis cell 50, electrical current is applied to an electrically conductive tab 54C provided on the anode 54 that serves as a positive terminal for the electrolysis cell 50. Another electrically conductive tab 62A provided on the input end cap 62 serves as a negative (neutral or ground) terminal for the electrolysis cell 50. Cathode 52 and anode 54 separate the electrically charged ions of the mixture of fresh water and brine across the porous membrane 56 into an NaOH solution at the cathode 52 and an HOCl solution at the anode 54 in a manner well known to those of skill in the art. As a result, the HOCl solution is available at an output port 60A provided on the output chamber 60 and the NaOH solution is available at an output port 60B likewise provided on the output chamber 60.

As mentioned previously, the pH of the HOCl solution is essentially dictated by the pH of the NaOH solution because NaOH has a naturally higher pH. Consequently, the introduction of additional NaOH into the EAW process results in a responsive increase in the pH of the HOCl solution. Conventional generators for producing HOCl solution and NaOH solution utilize a needle valve, pump or electrically controlled valve to create backpressure in the output line of the NaOH solution to introduce additional NaOH into the EAW process. However, these mechanisms and methods add cost and complexity to the manufacture of the generator, while reducing the reliability and accuracy of the generator due to the opportunity for technician error and inadvertent or malicious tampering. The inner walls of a needle valve create flow turbulence that results in an inconsistent pH of the HOCl solution and the moving parts of a pump or an electronic valve can wear over time, resulting in degradation of the ECA solutions. The present invention eliminates the cost, complexity, reliability and accuracy associated with these components of a conventional generator to thereby provide a more economical, less complex, more reliable and more accurate system and method for producing ECA solutions. By way of example and not limitation, the improved system 10, apparatus 30 and method of the invention eliminates the need for internal pH monitoring and flow meter components of the generator 30.

As best seen from FIG. 3 and FIG. 5, the output port 60A of the output chamber 60 is in fluid flow communication through a fluid coupling and fittings with the HOCl output conduit 16A leading to the HOCl tank 16. Similarly, the output port 60B of the output chamber 60 is in fluid flow communication through a fluid coupling and fittings with the NaOH output conduit 18A leading to the NaOH tank 18. However, in accordance with the present invention, a purely mechanical fixed flow restrictor (FFR) is positioned within the NaOH output conduit 18A between the output port 60B and the NaOH tank 18. In a particular embodiment the FFR is positioned within the NaOH output conduit 18A immediately after and adjacent to the output port 60B. Regardless, the FFR in the NaOH output conduit 18A operates to create a backpressure and thereby divert NaOH solution back to the electrolysis cell 50 through an NaOH return conduit 60C that leads to the input port 58B provided on the input chamber 58. In this manner, additional NaOH solution is recirculated back through the electrolysis cell 50 and acts to increase the pH of the HOCl solution due to the higher pH of the NaOH solution.

FIG. 11 is an enlarged perspective view of an exemplary embodiment of a FFR 70 for use with the generator 30 of the system 10. FIG. 12 is an enlarged cross-sectional view of the FFR 70 shown in FIG. 11. A fluid coupling comprises a threaded portion 72 and a hex head 73 for fluidly connecting the NaOH output conduit 18A with the NaOH return conduit 60C. The FFR 70 is disposed within the NaOH output conduit 18A and comprises an elongate, generally cylindrical insert 74 formed from a material that is at least relatively resistant to corrosion and has at least a relatively high hardness. By way of example only, the insert 74 may be made of a hard plastic material, such as a thermoplastic polymer. In an advantageous embodiment insert 74 is made of an HDPE or PEHD material. A fluid passageway 75 in the form of a longitudinally extending cylindrical bore is provided through the insert 74. In the illustrated embodiment, fluid passageway 75 is located concentrically within the insert 74.

Regardless, insert 74 has an outer diameter indicated by D1 that corresponds closely to the inner diameter of the NaOH output conduit 18A. As a result, insert 74 has a relative interference (friction) fit within the NaOH output conduit 18A that results in a fluid-tight connection between insert 74 and NaOH output conduit 18A. The insert 74 has a predetermined inner diameter indicated by D2 that defines the diameter of fluid passageway 75, and a predetermined length indicated by L that defines the length of the fluid passageway 75. The diameter D2 and the length L of fluid passageway 75 are dimensioned to create a backpressure that re-circulates a desired amount of the NaOH solution back through the electrolysis cell 50 via the return conduit 60C and input port 58B of input chamber 58. The NaOH solution re-circulated through the electrolysis cell 50 produces a desired pH of the HOCl solution.

It should be noted that in an advantageous embodiment, FFR 70 is removable from the NaOH output conduit 18A and interchangeable with another FFR 70 having a different diameter D2 and/or length L so that the pH of the HOCl solution delivered to the HOCl tank 16 via HOCl output conduit 16A can be precisely controlled. As will be readily apparent to those skilled in the art, varying the diameter D2 of the fluid passageway 75 (the inner diameter of insert 74) and the length L of the fluid passageway (the length of insert 74) changes the backpressure created in the NaOH output conduit 18A and thereby the amount of the NaOH solution diverted through return conduit 60C and re-circulated through the electrolysis cell 50 in a calculable manner. Consequently, the inner diameter D2 and the length L dimensions of the insert 74 can be selected to produce a desired hydrogen ion concentration to control the pH of the HOCl solution. Accordingly, the invention provides an associated method of controlling the pH of an HOCl solution produced utilizing the EAW process by selecting the diameter D2 of the fluid passageway 75 and/or the length L of the fluid passageway 75 of the FFR 70 for the electrolysis cell 50 of the generator 30.

In an advantageous embodiment, the inner diameter D2 of the interchangeable insert 74 is selected from about 0.02 to about 0.08 inches, preferably from about 0.025 to about 0.07 inches, and most preferably from about 0.055 to about 0.0625 inches, wherein the outer diameter D1 of the insert 74 is about 0.25 inches. In general, the length L of the insert 74 is less for a smaller diameter D2 of the fluid passageway 75 and the length L of the insert 74 is greater for a larger diameter D2 of the fluid passageway 75. The appropriate inner diameter D2 and length L dimensions of insert 74 to produce an ECA solution having a desired pH may be determined by a site survey of the water hardness and pH at a particular installation site. In addition, it should be noted that the FFR 70 may be located at any point within the NaOH output conduit 18A between the NaOH return conduit 60C and the NaOH tank 18. By way of example and not limitation, the FFR 70 alternatively may be positioned within the NaOH output conduit 18A adjacent the fluid coupling leading into the NaOH tank 18, as depicted in FIG. 1.

Alternatively or in addition, a FFR 80 configured in the same manner as FFR 70 described herein with reference to FIG. 11 and FIG. 12 may be provided for regulating the amount of pre-treated fresh water that is provided to the flow sensor switch 42 from the solenoid valve 40 through the fresh water flow conduit 40A. Thus, the FFR 80 may be positioned within the water input conduit 20A at any point between the water filtration unit 22 in fluid flow communication with the fill conduit 20 and a fluid coupling and/or fitting at the solenoid valve 40, as depicted in FIG. 3. Alternatively, FFR 80 may be positioned within fresh water flow conduit 40A between the solenoid valve 40 and the flow sensor switch 42, for example, at a fluid coupling and/or fitting at the flow sensor switch 42. The FFR 80 serves to control the amount (PPM) of FAC in the HOCl solution in a known manner that will be readily apparent and understood by those having ordinary skill in the art. Similar to FFR 70, the FFR 80 is interchangeable so that the FAC of the HOCl solution delivered to the HOCl tank 16 via HOCl output conduit 16A can be precisely controlled.

Thus, the system 10 may be provided with the interchangeable FFR 70 to precisely control the pH of the HOCl solution and/or with the interchangeable FFR 80 to precisely control the FAC in the HOCl solution produced by the generator 30 in the EAW process. Consequently, the FFR 70 and/or the FFR 80 serve to reduce the complexity, cost and maintenance of the system 10, while increasing the flexibility and reliability of the system 10 since the purely mechanical FFR 70 and/or 80 utilizes no moving parts and no electrical or computer controlled components.

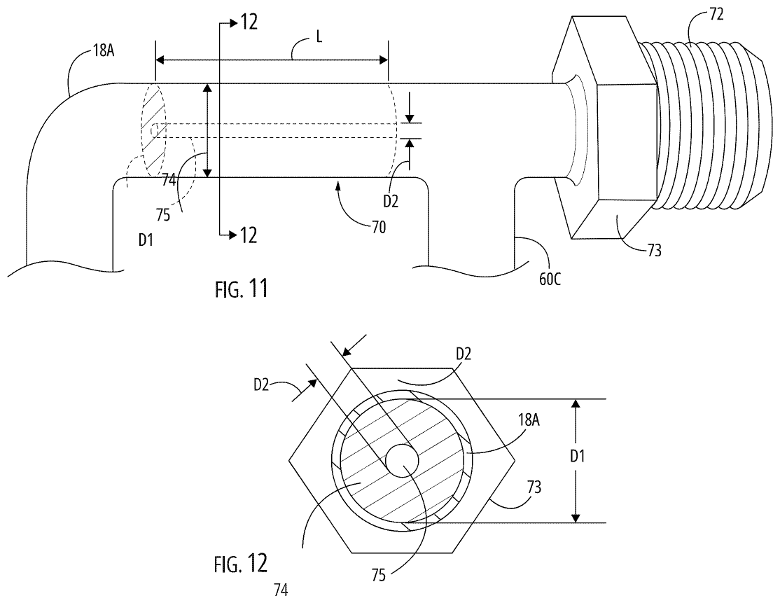

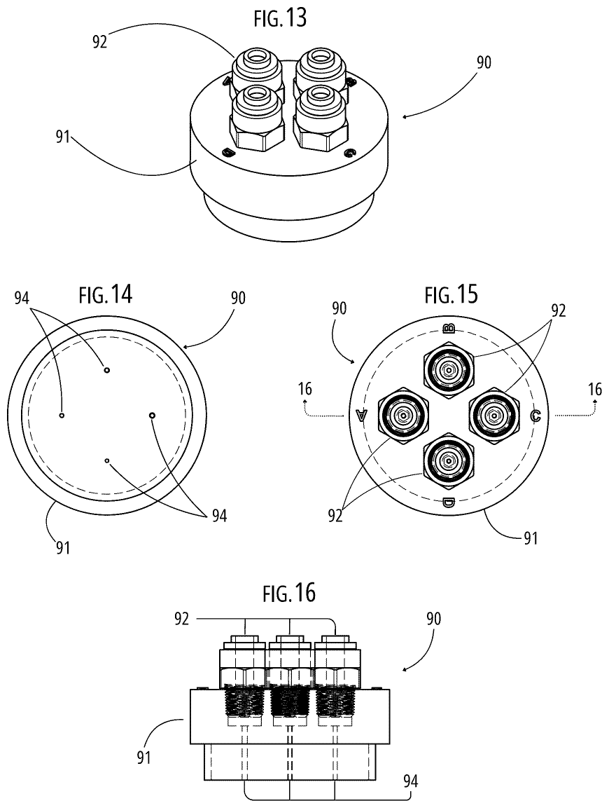

FIGS. 13-16 show an exemplary embodiment of a fixed flow restrictor (FFR) manifold 90 comprising a generally cylindrical manifold body 91 having a plurality of threaded fluid couplings 92 and a corresponding plurality of elongate inserts 94 formed in the manifold body 91. FIG. 13 shows a top perspective view of the FFR manifold 90. FIG. 14 shows a bottom plan view of the FFR manifold 90. FIG. 15 shows a top plan view of the FFR manifold 90. FIG. 16 shows a cross-sectional view of the FFR manifold 90 taken from FIG. 15. Each insert 94 defines a fluid passageway 95 in the form of a longitudinally extending cylindrical bore through the insert 94. Each insert 94 has a predetermined inner diameter indicated by D2 that defines the diameter of the fluid passageway 95, and a predetermined length indicated by L that defines the length of the fluid passageway 95. The exemplary embodiment of FFR manifold 90 illustrated by FIGS. 13-16 has a total of four (4) inserts 94 having different dimensions, namely, a different inner diameter D2. However, FFR manifold 90 may be configured with more or less inserts 94, each having a different inner diameter D2 and/or length L. Furthermore, the manifold body 91 may be configured in any suitable shape, for example square, rectangular, triangular, etc.

The FFR manifold 90 may be disposed within the NaOH output conduit 18A at any point between the return conduit 60C and the NaOH tank 18. In this instance, the diameter D2 and/or the length L of the fluid passageway 95 of each insert 94 are dimensioned to create a backpressure that re-circulates a different amount of the NaOH solution back through the electrolysis cell 50 via the return conduit 60C and input port 58B of input chamber 58, as previously described, and thereby produce a desired pH of the HOCl solution. Alternatively, or in addition, the FFR manifold 90 may be disposed within the water input conduit 20A at any point between the water filtration unit 22 and the flow sensor switch 42. In this instance, the diameter D2 and/or the length L of the fluid passageway 95 of each insert 94 are dimensioned to control the amount of fresh water delivered to the electrolysis cell 50 by the flow sensor switch 42 through water/brine input conduit 48, as previously described, and thereby produce a desired FAC in the HOCl solution.

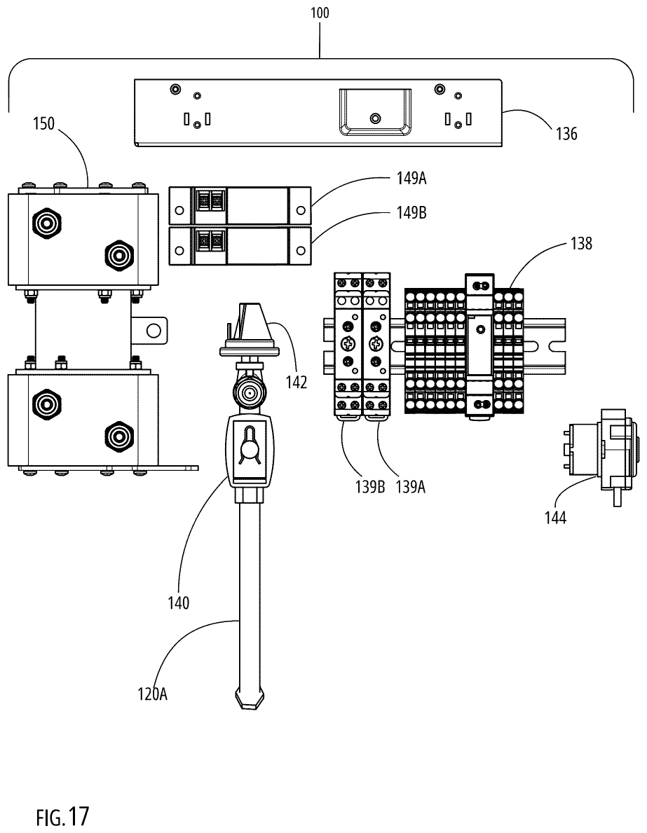

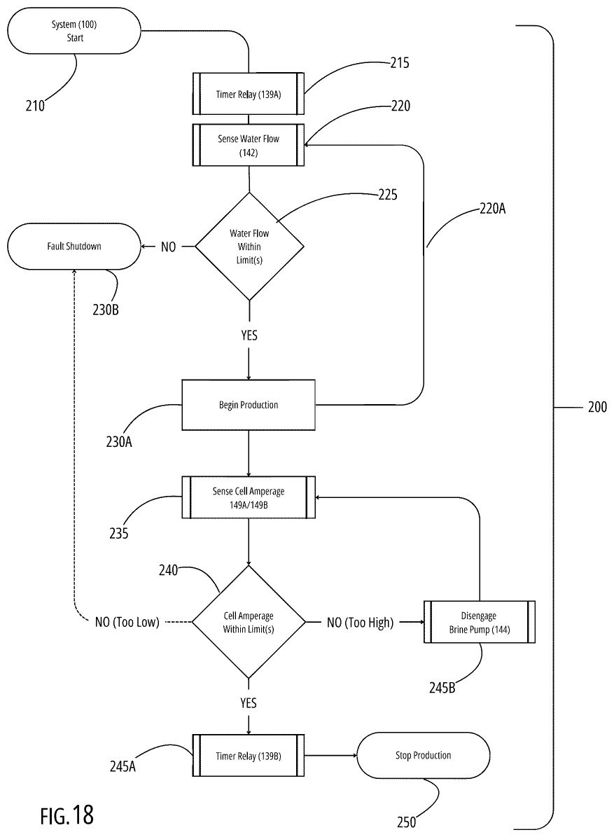

A further aspect of the invention is embodied by a system and method for optimizing the electrochemical production of HOCl solutions and NaOH solutions by the precise management and control of the water flow, electrolyte concentration and electric current variables in an EAW process. FIG. 17 shows schematically the components of a system 100 for the precise management and control of the electrolysis variables in an EAW process. FIG. 18 is a flowchart illustrating an exemplary embodiment of a method 200 associated with the system 100 for the precise management and control of the electrolysis variables in an EAW process.

The system 100 illustrated by FIG. 17 comprises fresh water input conduit 120A and brine pump 144 for delivering a mixture of fresh water and brine to an electrolysis cell 150, for example, in the manner previously described with respect to the system 10 and electrolysis cell 50. The system 100 further comprises a power supply 136 for supplying electrical power in the form of electric current to the various components of system 100. Power supply 136 is in electrical communication with electrical circuitry, for example, in the form of a contactor switch 138. The system 100 further comprises a first timer relay 139A operable for providing an On-Delay function and a second timer relay 139B operable for providing an Off-Delay function. A solenoid valve 140 is disposed within the fresh water input conduit 120A downstream of a flow/pressure sensor 142. The system 100 further comprises a first amperage sensor 149A configured and operable for sensing a high amperage condition and/or a second amperage sensor 149B configured and operable for sensing a low amperage condition.

The system 100 is a self-balancing system for optimizing the electrochemical production of HOCl solutions and NaOH solutions through the precise management of the water flow, electrolyte concentration, and electric current variables. EAW processes, such as electrolysis, are highly sensitive to the ratios of those variables. Deviations from the proper ratio of the water flow, electrolyte concentration and electric current variables can result in suboptimal or unsafe HOCl and NaOH solution outputs. Electrolysis system 100 ensures the proper ratios of those variables, enabling consistent and safe production of cleaning, degreasing, disinfecting and sanitizing solutions. Particularly, the self-balancing system 100 utilizes integrated current-sensing and flow-sensing technologies to adjust the electrical power delivered to the electrolysis cell 150 based on real-time conditions.

In one embodiment, the system 100 leverages current-sensing mechanisms to monitor the amperage of the electrochemical process occurring within the electrolysis cell 150. In particular, a first amperage sensor 149A of system 100 is operable to monitor the amperage within the electrolysis cell 150. The first amperage sensor 149A may be, for example, a shunt resistor, a Hall effect sensor, a current switch or the like. If the first amperage sensor 149A detects an amperage that exceeds a predetermined maximum threshold amperage, indicating an excessive electrolyte concentration, the electrical circuitry (e.g., contactor switch 138) shuts off electrical power to the brine pump 144. The loss, or reduction, of electrical power to the brine pump 144 halts, or reduces, the flow of electrolyte solution to the electrolysis cell 150, thereby allowing the fresh water delivered to the electrolysis cell 150 through the water input conduit 120A to temporarily dominate the water/brine mixture through the electrolysis cell 150, also referred to herein as the “cell flow.” The controlled dilution of the cell flow lowers the electrolyte concentration within the electrolysis cell 150 to bring the electrolysis system 100 back into balance.

Once the amperage within the electrolysis cell 150 drops below the predetermined maximum threshold amperage, the electrical circuitry (e.g., contactor switch) 138 returns, or increases, electrical power to the brine pump 140 to resume balanced operation of the electrolysis system 100. The momentary imbalance of the electrolysis system 100 does not compromise the overall concentration of the HOCl and NaOH solutions as the temporary increase in amperage produces a higher-than-normal concentration that is diluted by the temporary dominant fresh water to restore the end solutions to a normal result, ensuring that the concentrations of the HOCl and NaOH solutions remain within the desired efficacy. While system 100 is in the high-amperage state, an alarm or alert condition is engaged to prompt an operator/technician to investigate and resolve the situation.

In another embodiment, the electrolysis system 100 may alternatively, or in addition, include a second amperage sensor 149B operable to monitor the amperage within the electrolysis cell 150. The second amperage sensor 149B may be, for example, a shunt resistor, a Hall effect sensor, a current switch or the like. The second amperage sensor 149B monitors the amperage within the electrolysis cell 150 to ensure there is a sufficient electrolyte concentration for the electrochemical generation of HOCl solutions having a desired FAC concentration. If the second amperage sensor 149B detects an amperage that is less than a predetermined minimum threshold amperage, indicating an insufficient electrolyte concentration, the electrical circuitry (e.g., contactor switch 138) shuts off electrical power to the entire system 100 and activates an alarm or alert condition to prompt an operator/technician to investigate and resolve the situation. This protective measure ensures the electrolysis system 100 continues to consistently produce HOCl solutions within safe and effective FAC concentration ranges.

A safety feature of the electrolysis system 100 is the ability to prevent the overproduction and release of harmful chlorine gas. Chlorine gas can release from solution if the water flow through fresh water input conduit 120A is interrupted or significantly reduced, leaving the electrolysis cell 150 with an excessive concentration of brine in the water/brine mixture. To counteract this situation, system 100 employs at least one timer relay to monitor the water flow through a solenoid valve. In particular, system 100 uses the first timer relay 139A having the On-Delay function and the second timer relay 139B having the Off-Delay function to allow the fresh water to flow through the solenoid valve 140 to the flow/pressure sensor 142 within the fresh water input conduit 120A for a specified time period. If the flow/pressure sensor 142 detects sufficient water flow during the specified time period, the system 100 continues to operate. However, if no or too little water flow is detected by the flow/pressure sensor 142, for example due to a closed solenoid valve 140 or a flow restriction within the fresh water input conduit 120A, the electrical circuitry (e.g., contractor switch 138) shuts down the entire electrolysis system 100. The shutdown of the entire system is useful not only for preventing the release of excess chlorine gas, but also for protecting the electronic components of system 100 from the high electric current associated with an elevated electrolyte concentration. This safety feature adds another layer of protection, ensuring that the system 100 maintains a stable and secure environment for users and operators/technicians alike.

FIG. 18 illustrates an exemplary embodiment of the method 200 associated with the system 100 for the precise management and control of the electrolysis variables in an EAW process. The method 200 includes starting the system 100 indicated at 210. The system 100 at 215 then employs the electrical circuitry (e.g., contactor switch 138) to activate the first timer relay 139A having the On-Delay function. System 100 next at 220 utilizes the flow/pressure sensor 142 to sense the water flow. The operating logic of the system 100 at 225 determines whether the water flow is below an acceptable predetermined minimum limit (or alternatively is above an acceptable predetermined maximum limit). If the water flow is within the acceptable limit(s), the operating logic of the system 100 begins normal production of the HOCl and NaOH solutions at 230A. The system 100 at 220A periodically utilizes the flow/pressure sensor 142 to sense the water flow and production continues as long as the water flow is within the acceptable limit(s). If the water flow is not within the acceptable limit(s), the operating logic of the system 100 identifies the fault and causes the electrical circuitry (e.g., contactor switch 138) to immediately shut down further operation of the electrolysis system 100 at 230B, at least until an operator/technician resolves the issue and resets the operating logic.

Another exemplary embodiment of the method 200 associated with the system 100 is further illustrated by FIG. 18. The system 200 at 235 utilizes at least one amperage sensor (e.g., high amperage sensor 149A/low amperage sensor 149B) to sense the amperage within the electrolysis cell 150. The operating logic of the system 100 at 240 determines whether the cell amperage is below an acceptable predetermined maximum limit or above an acceptable predetermined minimum limit. If the cell amperage is within the acceptable predetermined limits, normal production continues until the HOCl and NaOH solutions are produced by the electrolysis cell 150. The system 100 at 245A then employs the electrical circuitry (e.g., contactor switch 138) to activate the second timer relay 139B having the Off-Delay function until normal production is stopped at 250. If the cell amperage is not within the acceptable predetermined limits and is too high (i.e., above the predetermined maximum limit), the operating logic of the system 100 identifies the fault and causes the electrical circuitry (e.g., contactor switch 138) to temporarily disengage (shut down or reduce) further operation of the brine pump 144 at 245B, at least until an operator/technician resolves the issue and resets the operating logic. The system 100 at 235A periodically utilizes the at least one amperage sensor 139A, 139B to sense the cell amperage and normal production resumes once the cell amperage is within the acceptable predetermined maximum and minimum limits. If the cell amperage is not within the acceptable predetermined limits and alternatively is too low (i.e., below the predetermined maximum limit), the operating logic of the system 100 identifies the fault and causes the electrical circuitry (e.g., contactor switch 138) to immediately shut down further operation of the electrolysis system 100 at 230B, at least until an operator/technician resolves the issue and resets the operating logic.

As previously described with reference to FIGS. 13-16, the system 10, 100 may incorporate an embedded FFR manifold 90 equipped with multiple inserts 94 each having a different inner diameter D2. Although not shown, the inserts 94 may alternatively, or in addition, have a different length L. The multiple inserts (i.e., FFRs) 94 of the manifold 90 play an important role in regulating the water flow rates and electrolyte concentrations through the electrolysis cell 150. Environmental factors, such as seasonal changes in municipal water treatment or variations in water hardness, can affect the performance of the system 10, 100 making it necessary to periodically change or adjust one or both of the FFRs for controlling the pH of the HOCl solution and/or the FAC in the HOCl solution. The FFR manifold 90 allows an operator/technician to readily (quickly and easily) select the most effective FFR(s) for the changing environmental conditions, ensuring that the system 10, 100 remains within optimal operating parameters.

By providing the FFR manifold 90 with a wide range of pre-configured inserts (i.e., FFRs) 94 and installation options, the system 10, 100 gives operators/technicians the flexibility to fine-tune the water flow rates and produce HOCl solutions having pH levels and FAC according to the particular environmental conditions of the installation site. In practice, the manifold 90 allows for multiple FFRs to be installed in parallel, each capable of providing different water flow rates to ensures that, regardless of fluctuations in water supply characteristics and environmental conditions, the system 10, 100 will maintain its desired operational efficiency and precision. Advantageously, the manifold 90 can be embedded, for example, into the NaOH tank 18 to continuously monitor and adjust the water flow rate, further enhancing the ability of the system 10, 100 to respond to real-time water supply characteristics and environmental conditions. The embedded manifold 90 prevents unauthorized tampering or inadvertent misuse, as any deviation from the intended configuration will automatically trigger the self-balancing system 100 preventing the production of out-of-specification HOCl and NaOH solutions. Inclusion of the FFR manifold 90 not only provides enhanced flexibility and improved precision, but also increases the overall security of the system 100. If untrained or malicious users attempt to tamper with the FFRs or bypass the FFR manifold 90, the self-balancing capabilities of the system 100 will automatically engage, preventing the production of HOCl and NaOH solutions with undesirable concentrations. This adaptive self-balancing feature maintains the integrity of the system 100 in variable field conditions, thereby providing a user-friendly approach to managing EAW processes.

Overall, the present invention provides adaptive systems, apparatus and methods for the electrochemical generation of HOCl and NaOH solutions. Embodiments of the systems, apparatus and methods feature advanced self-balancing components for the precise management and control of HOCl and NaOH solutions, enhanced safety controls, and a multiple FFR manifold to ensure optimal performance under varying water supply characteristics and environmental conditions. The innovations disclosed herein extend the utility and reliability of electrochemical generation systems, apparatus and methods, making them safer, more efficient, and more adaptable to a range of real-world conditions and environments.

The foregoing detailed description of aspects and exemplary embodiments of systems, apparatus and associated methods is merely illustrative of the general concepts and principles of the present invention. Irrespective of the foregoing detailed description of the illustrated exemplary embodiments, various other systems, apparatus and other associated methods, as well as reasonable equivalents thereof, will be readily apparent and understood by those having ordinary skill in the art. Accordingly, equivalents to those shown in the accompanying drawing figures and described in the written description are intended to be encompassed by the broadest reasonable interpretation and construction of the appended claims. Furthermore, as numerous modifications and changes to the exemplary embodiments will readily occur to those skilled in the art, the invention is not to be limited to the specific configuration, construction, materials, manner of use and operation shown and described herein. Instead, all reasonably predictable and suitable equivalents and obvious modifications to the invention should be determined to fall within the scope of the appended claims given their broadest reasonable interpretation and construction in view of the accompanying written description and drawing figures and the combined disclosures and teachings of any relevant prior art.

That which is claimed is:

1. A system for producing an electrochemically activated (ECA) solution, comprising:
a source of water;
a source of brine;
a source of electric current;
a generator operable for producing the ECA solution utilizing the electric current and a mixture of the water and the brine; and
a mechanical fixed flow restrictor (FFR) manifold comprising a plurality of inserts each having a longitudinal fluid passageway that defines a different diameter and/or a different length, wherein each insert is operable for controlling at least one of a pH of the ECA solution and a free available chlorine (FAC) in the ECA solution.

2. The system according to claim 1, wherein the ECA solution is a hypochlorous acid (HOCl) solution.

3. The system according to claim 1, wherein the diameter of the fluid passageway is selected to be between about 0.02 and about 0.08 inches.

4. The system according to claim 1, wherein the generator comprises an electrolysis cell having a cathode, an anode and a membrane disposed between the cathode and the anode.

5. The system according to claim 4, wherein the generator further comprises a power supply for supplying electrical power to a timer relay and a flow sensor switch in electrical communication with the timer relay that controls a supply of the water from the source of water to the electrolysis cell, and wherein the flow sensor switch in conjunction with the timer relay prevents release of an excess of a chlorine (Cl) gas by shutting down operation of the generator in the event of an insufficient supply of the water from the source of water.

6. The system according to claim 5, wherein the FFR manifold is disposed between the source of water and the flow sensor switch and is operable for controlling the FAC in the ECA solution by regulating the amount of water in the mixture of the water and the brine.

7. The system according to claim 4, further comprising:
a first output conduit in flow communication with the electrolysis cell and a first receptacle for receiving a first ECA solution from the electrolysis cell; and
a second output conduit in flow communication with the electrolysis cell and a second receptacle for receiving a second ECA solution from the electrolysis cell;
wherein the FFR manifold is disposed within the second output conduit between the electrolysis cell and the second receptacle and operable for controlling the pH of the first ECA solution.

8. The system according to claim 7, wherein the first ECA solution is a hypochlorous acid (HOCl) solution and the second ECA solution is a hydroxide solution, and wherein the FFR manifold re-circulates a portion of the hydroxide solution to produce a desired pH of the HOCl solution.

9. The system according to claim 8, wherein the FFR manifold creates a backpressure in the second output conduit to recirculate the portion of the hydroxide solution through the electrolysis cell and thereby increase the pH of the HOCl solution.

10. The system according to claim 1, wherein the ECA solution is a hypochlorous acid (HOCl) solution and wherein a first FFR manifold controls the FAC in the HOCl solution and a second FFR manifold controls the pH of the HOCl solution.

11. The system according to claim 10, wherein the first FFR manifold restricts the amount of water in the mixture of the water and the brine delivered to an electrolysis cell and the second FFR recirculates a hydroxide solution to the electrolysis cell.

12. A system for optimizing the electrochemical production of an electrochemically activated (ECA) solution in an electrochemically activated water (EAW) process, comprising:
an electrolysis cell;
a water input conduit for delivering water to the electrolysis cell;
a brine pump for delivering brine to the electrolysis cell;
a power supply;
electrical circuitry in electrical communication with the power supply; and
at least one amperage sensor;
wherein the at least one amperage sensor monitors an amperage within the electrolysis cell.

13. The system according to claim 12, wherein the electrical circuitry shuts off or reduces power from the power supply to the brine pump if the at least one amperage sensor detects the amperage within the electrolysis cell exceeds a predetermined maximum threshold amperage.

14. The system according to claim 12, wherein the electrical circuitry shuts off power from the power supply to the system if the at least one amperage sensor detects the amperage within the electrolysis cell is less than a predetermined minimum threshold amperage.

15. The system according to claim 12, further comprising at least one timer relay, a solenoid valve and a flow/pressure sensor;
wherein the at least one timer relay is operable for allowing a water flow through the solenoid valve for a specified time period; and
wherein the flow/pressure sensor detects the water flow through the solenoid valve for the specified time period the electrical circuitry shuts off power from the power supply to the system if the flow/pressure sensor detects the water flow is below a predetermined minimum acceptable limit during the specified time period.

16. A system for optimizing the electrochemical production of an electrochemically activated (ECA) solution in an electrochemically activated water (EAW) process, comprising:
an electrolysis cell;
a water input conduit for delivering water to the electrolysis cell;
a power supply;
electrical circuitry in electrical communication with the power supply; and
at least one timer relay;
wherein the at least one timer relay monitors a water flow from the water input conduit to the electrolysis cell.

17. The system according to claim 16, further comprising a flow/pressure sensor and a solenoid valve, and wherein the flow/pressure sensor detects the water flow through the solenoid valve for a specified time period.

18. The system according to claim 17, wherein the at least one timer relay comprises a first timer relay having an On-Delay function and a second timer relay having an Off-Delay function operable for allowing the water flow through the solenoid valve to the flow/pressure sensor within the water input conduit for the specified time period.

19. The system according to claim 18, wherein the electrical circuitry shuts off power from the power supply if the flow/pressure sensor detects the water flow is below a predetermined minimum acceptable limit during the specified time period to prevent an overproduction and release of a chlorine (Cl) gas.

20. The system according to claim 16, further comprising a brine pump and at least one amperage sensor for monitoring an amperage within the electrolysis cell;
wherein the electrical circuitry shuts off or reduces power from the power supply to the brine pump if the at least one amperage sensor detects the amperage within the electrolysis cell exceeds a predetermined maximum threshold amperage; or
wherein the electrical circuitry shuts off power from the power supply to the system if the at least one amperage sensor detects the amperage within the electrolysis cell is less than a predetermined minimum threshold amperage.
